(19) United States
(12) Patent Application Publication
(10) Pub. No.: US 2021/0159566 A1
(43) Pub. Date: May 27, 2021

(54) Battery Pack

(71) Applicant: Kevin Stephen DAVIES, Duncraig (AU)

(72) Inventor: Kevin Stephen DAVIES, Duncraig (AU)

(21) Appl. No.: 16/954,162

(22) PCT Filed: Dec. 14, 2018
(86) PCT No.: PCT/AU2018/051339

§ 371 Date: Jun. 15, 2020

(30) Foreign Application Priority Data
Dec. 15, 2017 (AU) 2017905027
Mar. 15, 2018 (AU) 2018900851

(51) Int. Cl. H01M 50/204; H01M 10/04; H01M 10/42; H01M 10/643; H01M 10/6563; H01M 50/107; H01M 50/502

(52) U.S. Cl. CPC H01M 50/204; H01M 10/0481; H01M 10/425; H01M 50/502; H01M 10/6563; H01M 50/107; H01M 10/643

(57) ABSTRACT

A battery pack (10) comprising a plurality of boards (12) having contacts thereon for contacting terminal of a plurality of cells (14). A plurality of cell guides (18) are provided to each receive a plurality of the cells (18). A plurality of tensioning members (32) are provided wherein the tensioning members (32) pass through holes (20) in the boards (12) to engage with first and second endmost boards (12) in order to pull together the boards (12) and thereby engage the terminal of the cells (14) with the contacts on the boards (12).

### FIELD OF THE INVENTION

The present invention relates to a battery pack comprising a plurality of cells connected for supplying power.

### BACKGROUND TO THE INVENTION

Battery packs are used for storage of energy in many applications. Such battery packs commonly comprise a plurality of individual cells which are interconnected to form a pack capable of supplying power for a particular application. The cells in such battery packs are generally permanently connected within the pack, for example by wire straps welded directly connected to the terminals of the cells and/or wires that electrically connect multiple cells to control devices for the purpose of monitoring cells and balancing cell voltages. Such wired connections generally comprise connectors that plug to printed circuit boards (PCB). If any particular cells are faulty or underperforming, it is therefore difficult to identify and replace such cells.

The present invention relates to a battery pack in which a plurality of cells are connected to form an energy storage device. The battery pack of the present invention provides for the ability to individually monitor and balance cells within the battery pack, as well as allowing for easy disassembly of the battery pack to replace cells as required.

The battery pack of the present invention may have groups of cells connected electrically to separate outputs to provide inputs for an inverter of the type described in the applicant's earlier International patent application published under number WO02015184512.

### SUMMARY OF THE INVENTION

According to one aspect of the present invention there is provided a battery pack comprising:

a plurality of boards having contacts thereon for contacting terminals of a plurality of layers of cells, each layer of cells being received between an adjacent pair of boards;
a plurality of cell guides provided to each receive a plurality of the cells such that when the cell guides are received between the adjacent pair of boards, terminals of the cells are located adjacent contacts on the boards; and a plurality of tensioning members;
wherein the tensioning members pass through aligned holes in each of the boards to engage with first and second endmost boards in order to pull together the boards, the tensioning members being distributed across the extents of each of the boards in order to distribute a clamping force across the boards in order to engage the terminal of the cells with the contacts on the boards.

Preferably each of the boards includes contacts on first and second side surfaces being aligned such that the cells form columns of connected cells.

Preferably at least one tensioning member is provided adjacent each of the columns of cells to clamp the terminals of the cells of the columns into contact with the contacts on the boards.

In a preferred embodiment, a tensioning member is provided between each adjacent pair of columns of cells.

In a preferred embodiment, each of the tensioning member comprises an elongate member having opposed ends thereof engaged with the first and second endmost boards.

Preferably the contacts on the first and second side surfaces of the boards are each connected to a conductor extending along the side surfaces of the boards to one of a plurality of edge connectors provided along an edge of the board to allow for monitoring by a control unit of the characteristics of the cell in use.

Preferably a connector is provided for engaging with the edge connectors of each of the boards in order to provide connection to the control unit.

Preferably the connectors are flexible such that the connectors will allow for some relative movement of the boards when tensioning the battery pack.

In a preferred embodiment, the tensioning members each comprise a pair of arms extending outwardly from a base member, the arms being received through holes in the boards such that when the base member engages with a first endmost board, distal ends of the arms engage with an end member located adjacent a second endmost board.

Preferably the base member is resiliently flexible such that the base member may be pushed toward the first endmost board such that the distal ends of the arms engage with the end member, thereby applying tension when the base member is released.

Preferably the end members each have flexible tabs aligned with the arms such that first teeth on inner surfaces of distal ends of the arms engage with second teeth on outer surfaces of tabs to allow movement of the arms relative to the end member in a direction away from an outer surface of the second endmost board but restrict movement of the arms back towards the outer surface of the second endmost board.

Preferably the first and second teeth comprise triangular teeth provide to engage with each other and thereby restrict motion of the distal ends of the arms through the end members in a direction toward the outer surface of the second endmost board.

In a preferred embodiment, a locking plate is provided having openings to receive the end members such that edges of the openings align the distal ends of the arms towards the tabs, thereby engaging the first teeth on the arms with the second teeth on the tabs.

Preferably the openings in the locking plate correspond in shape to the shape of the end members and the end members are provided with flexible clips around the periphery thereof such that the flexible clips engage with edges of the openings to hold the locking plate relative to the second endmost board.

Preferably the base member comprises an elongate member having first and second ends and includes a resilient mechanism formed by the first and second ends flexing about a central location between the first and second ends.

Preferably a first side surface of the base member includes tapered outer ends such that portions of the first side surface adjacent the first and second ends engage the board before a centre of the first side surface, such that pressing the centre of the base member toward the board resiliently flexes the base member.

Preferably the base member includes a central opening on a first side surface thereof to receive a spring plate extending from adjacent the first end to adjacent the second end.

In a preferred embodiment, the plate is received under a cross member extending centrally across the opening between the first and second ends on a second side surface of the base member such that the base member may be flexed by pushing inwardly on the cross member, thereby flexing the plate.

In a further embodiment, the tensioning members comprise elongate wires having hooks on opposed ends thereof to engage with end members locatable on outer surfaces of the endmost boards.

Preferably the hooks are engaged into notches on a central portion of the end members.

Preferably the cell guides comprise a frame formed from a plurality of the tubular portions, each of the tubular portions being provided to receive one or more cells.

Preferably the cell guides are formed from a flexible resilient material.

Preferably the cell guides are provided with locating members to engage with the frame and engage also with the boards in order to locate the cell guides relative to the boards.

Preferably the locating members each comprise one or more rods having first ends receivable in support holes provided around the periphery of the frame and second ends receivable in locating holes provided on the boards.

Preferably the tensioning members or end members include a weakened section to allow breakage when subject to a sufficient impact force in order to electrically disconnects some of the cells.

In one embodiment, there is provided three layers of cells and four boards.

### BRIEF DESCRIPTION OF THE DRAWINGS

The invention will now be described, by way of example, with reference to the following drawings, in which:

FIG. 1 is an upper perspective view of a battery pack in accordance with the present invention;

FIG. 2 is a lower perspective view of the battery pack of FIG. 1;

FIG. 3 is a further upper perspective view of the battery pack of FIG. 1;

FIG. 4 is a top view of a locking plate of the battery pack of FIG. 1;

FIG. 5 is an upper perspective view of a cell guide of the battery pack of FIG. 1;

FIG. 6a is an upper perspective view of the cell guide holding a plurality of cells;

FIG. 6b is a lower perspective view of the cell guide holding a plurality of cells;

FIG. 7 is a view of a tensioning member and an end member of the battery pack;

FIG. 8a is an upper perspective view of the base member of the tensioning member of FIG. 7;

FIG. 8b is a lower perspective view of the base member of the tensioning member;

FIG. 9a is an upper perspective view of an end of the tensioning member engaged with the end member;

FIG. 9b is a lower perspective view of the end of the tensioning member engaged with the end member;

FIG. 10a is an upper perspective view of the end member;

FIG. 10b is a close up view of an end of the arms of the tensioning member;

FIG. 11 is a view of the battery pack with a board, cell guides and cells removed to show a tensioning member passing through a cell guide;

FIG. 12 is a view of a second embodiment of a battery pack in accordance with the present invention;

FIG. 13 is view of the battery pack of FIG. 12 with the cells removed;

FIG. 14 is an upper perspective view of a cell guide of the battery back of FIG. 12;

FIG. 15 is a view of cell guides received through one of the boards;

FIG. 16 is a view of the tensioning member and the end member of the battery pack of FIG. 12; and

FIG. 17 is a close up view showing the tensioning members engaging with the end members on an outer surface of the endmost board.

### DETAILED DESCRIPTION OF PREFERRED EMBODIMENTS

Referring to the Figures, there is shown a battery pack 10 comprising a plurality of boards 12, between which are secured a plurality of cells 14. The battery pack 10 may be covered in use by an outer cover (not shown). In the embodiment shown, there are provided four such boards 12. The boards 12 are arranged parallel to each other in a stacked configuration such that three layers of cells 14 are mounted between the boards 12. It will be appreciated however that alternative numbers of boards 12 and cells 14 may be used.

The boards 12 include contacts thereon such that terminals on ends of the cells 14 engage with the contacts on the surfaces of the boards 12. Each of the boards 12 includes contacts on a first side surface and contacts on an opposite second side surface. Each of the contacts on the first side surface of each board 12 is electrically connected to a corresponding contact on the second side of the board 12. When the cells 14 are provided between an adjacent pair of boards 12, the cells 14 are therefore connected together to form a column of electrically connected cells 14 that is capable of carrying high current to be provided by the battery back 10 to its load. Pairs of contacts on the outer surfaces of the endmost boards 12 may be interconnected such that each connected column of cells 14 may be electrically connected to one or more adjacent columns of cells 14. The endmost boards 12 also include high current interconnections between columns of cells 14 to electrically series connect the columns of cells 14 and output connectors for delivery of power from the cells 14 to a load.

The contacts on the first and second side surfaces of the boards 12 are also connected to conductors extending along the side surfaces of the boards 12. The conductors extend from each of the contacts to a control unit that monitors the cell voltage, reports the status of the cells and balances the cell voltages according to the measured voltages. The control unit of the preferred embodiment (not shown) is plugged into a plurality of edge connectors 34 on the edges of boards 12 via connectors.

The connectors are preferably flexible such that the connectors will allow for some movement of the boards 12 relative to the edge connectors 34 when tensioning the battery pack 10. In the preferred embodiment, the boards 12 incorporate a routed slot (not shown) along the length of the edge connectors 34 between the cells and edge connectors 34 to enable the relative movement. According to other embodiments the control unit may be designed on the boards directly or partially onto the boards 12 with multiplexing of the cell connections taking place on the boards 12 to reduce the number of connections required for monitoring and balancing the cells.

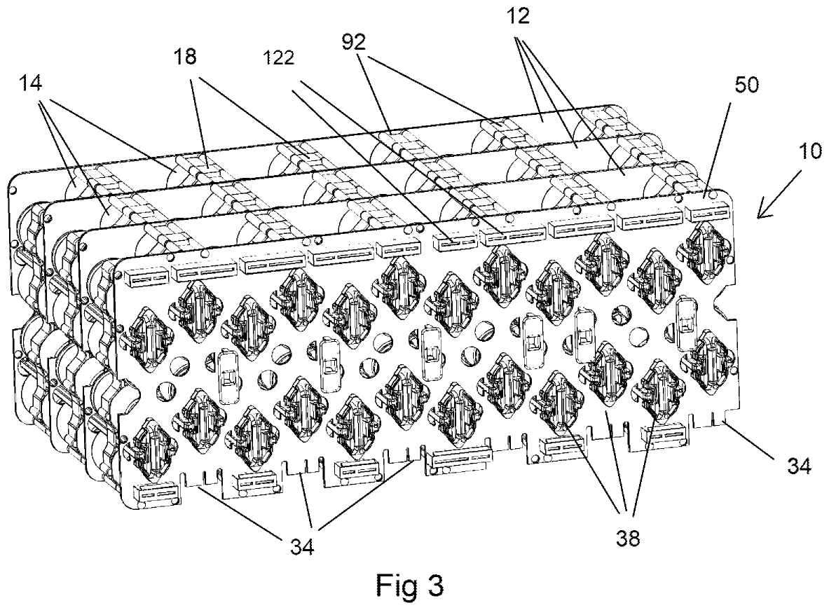

The cells 14 of the battery pack 10 may be electrically connected in groups to form a number of isolated sub-packs. In the preferred embodiment, the battery pack 10 consists of six such sub-packs each of twenty four series connected cells 14. Each of these sub-packs (in double rows from top to bottom of FIG. 3) routes the high current that flows through the columns of cells 14 into closely located female connectors 122 for control by an Inverter that switches the packs around to form a stepwise approximation of a sine wave.

The cells 14 are supported between adjacent pairs of boards 12 in layers by a plurality of cell guides 18. The cell guides 18 engage with the boards 12 such that ends of the cells 14 are supported by the cell guides 18 in order to restrict lateral movement of the cells 14 relative to the boards 12 and to align the boards 12 relative to each other.

Each of the cell guides 18 comprises a frame 24 formed from a plurality of connected tubular portions 22. The tubular portions 22 each define an opening 26 provided to receive one or more cells 14. In the embodiment shown, each of the openings 26 is provided to receive two cells 14. Each of the tubular portions 22 is provided with protrusions 23 extending inwardly into the defined opening 26 in order to locate the cells 14 within the opening 26. The cell guides 18 are formed from a flexible resilient material, such as a suitable plastic, such that the tubular portions 22 flex outwardly slightly as the cells 14 are received within the openings 26. The cells 14 are thereby gripped and retained within the frame 24. The cell guides 18 are to receive the cells 14 such that the cell guides 18 are located generally midway between the ends of the cells 14.

The cell guides 18 are provided with locating members 92. The locating members 92 comprise members which engage with the frame 24 and engage also with the boards 12 in order to locate the cell guides 18 correctly relative to the boards 12 such that the terminals of the cells 14 are located adjacent the contacts on the boards 12.

The locating members 92 each comprise one or more rods 94 having first ends receivable in support holes 28 provided around the periphery of the frame 24 and second ends receivable in locating holes 95 provided on the boards 12. In the embodiment shown, the locating members 92 each comprise a pair of rods 94 connected by an interconnecting portion 96 such that the rods 94 are parallel to each other.

The battery pack 10 includes also a plurality of tensioning members 32. The tensioning members 32 comprise elongate members extending between a first endmost board 12 and a second endmost board 12. The tensioning members 32 extend through aligned holes 20 in the boards 12. The tensioning members 32 are distributed across the extents of the boards 12 such that the tensioning members 32 provide a clamping force located adjacent each of the columns of cells 14 such that the terminals of the cells 14 of each column engage sufficiently with the contacts on the boards 12.

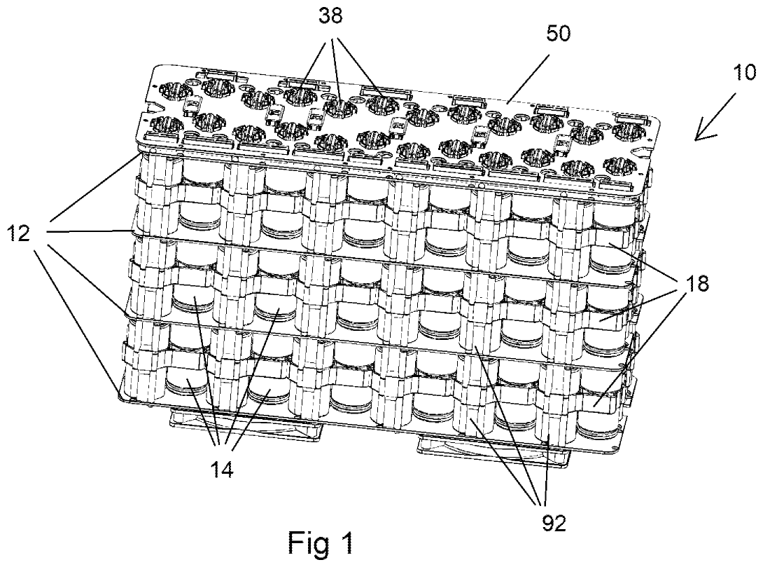

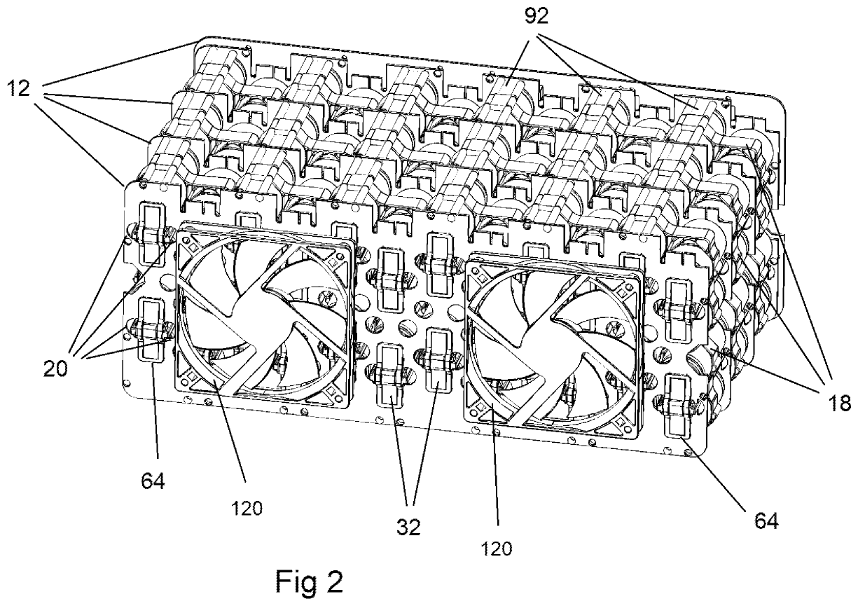

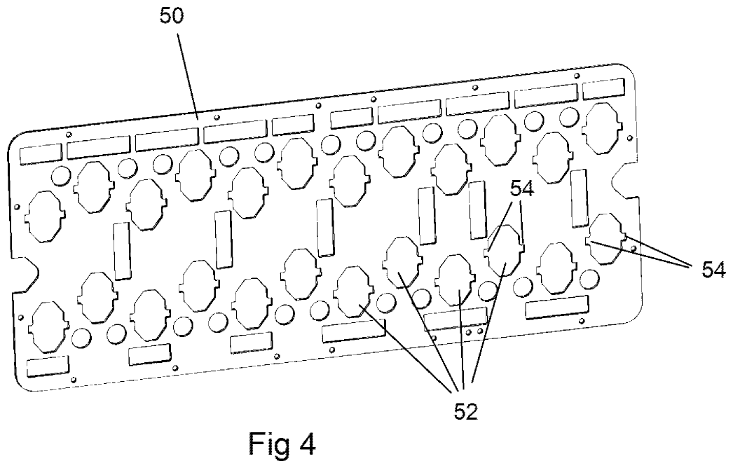

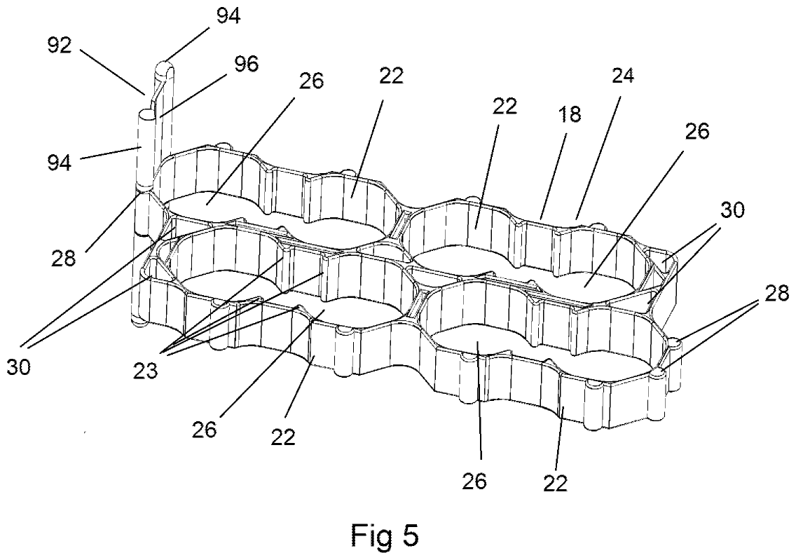

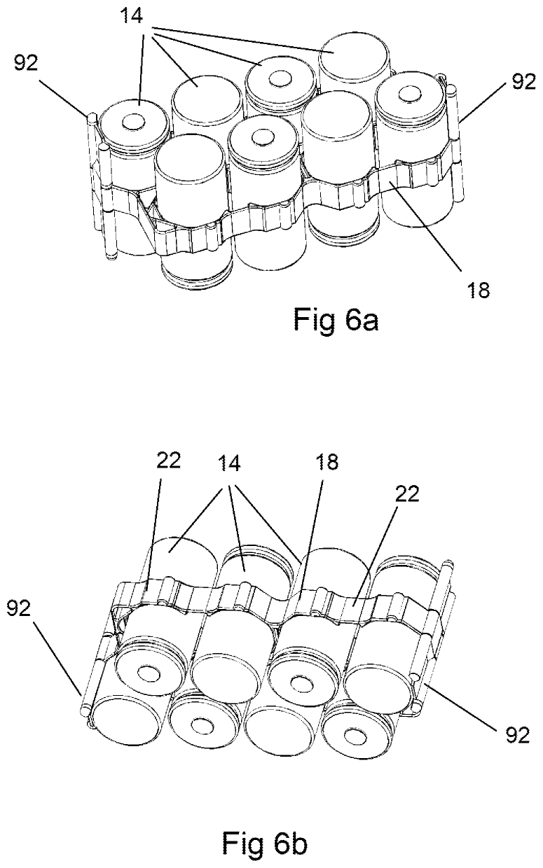

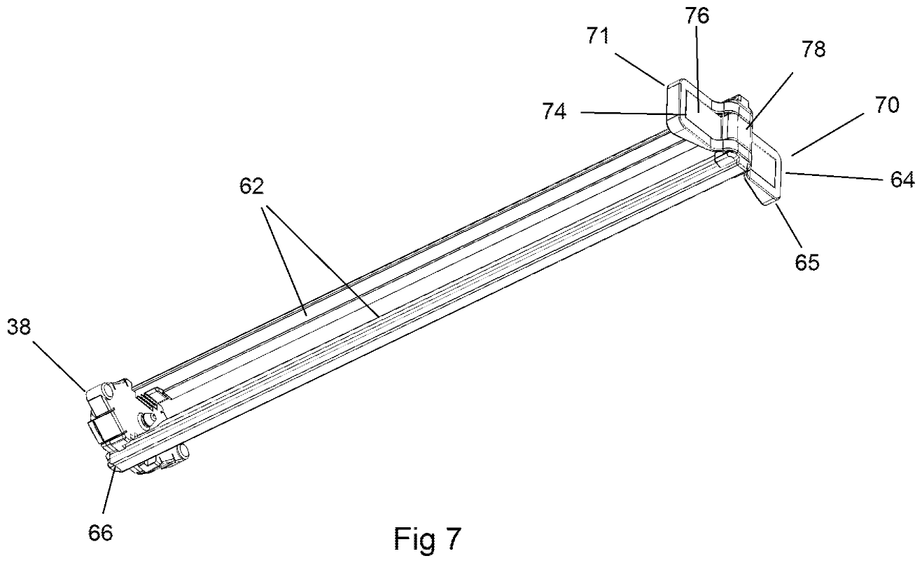

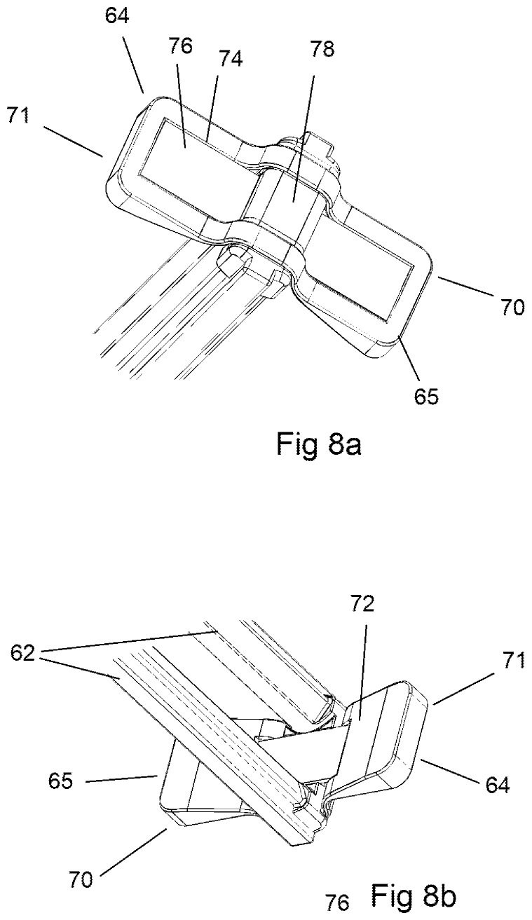

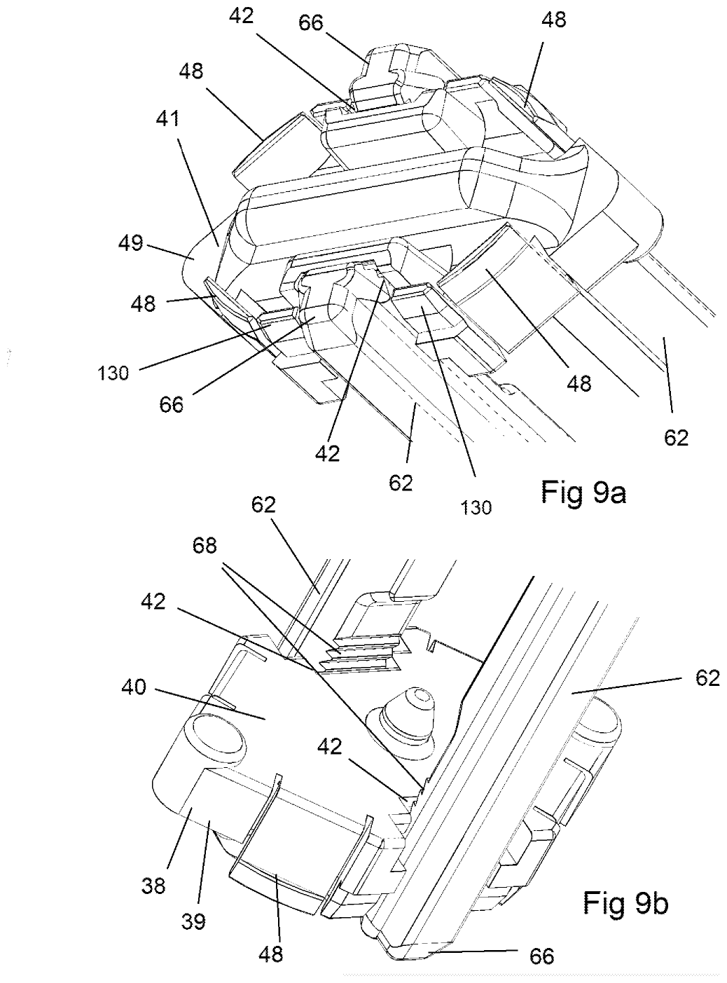

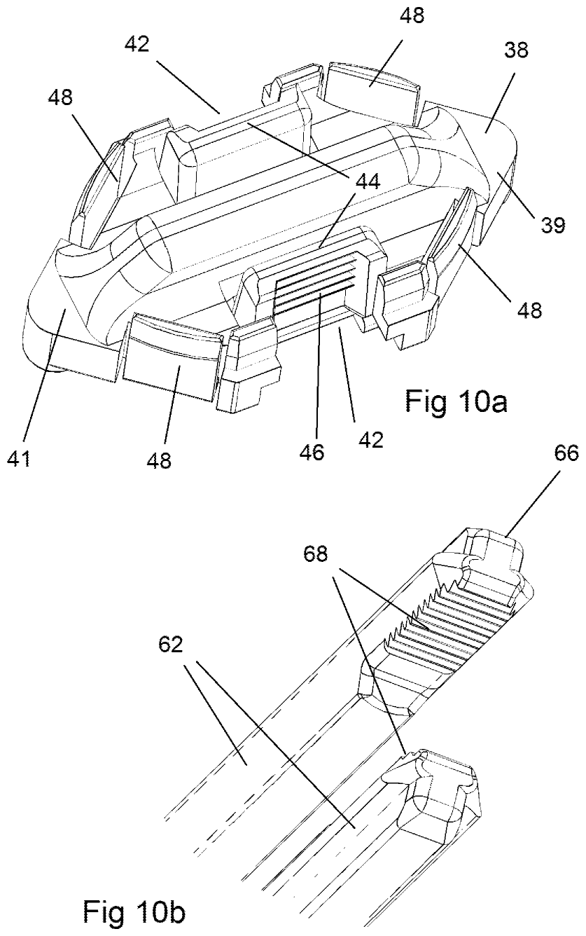

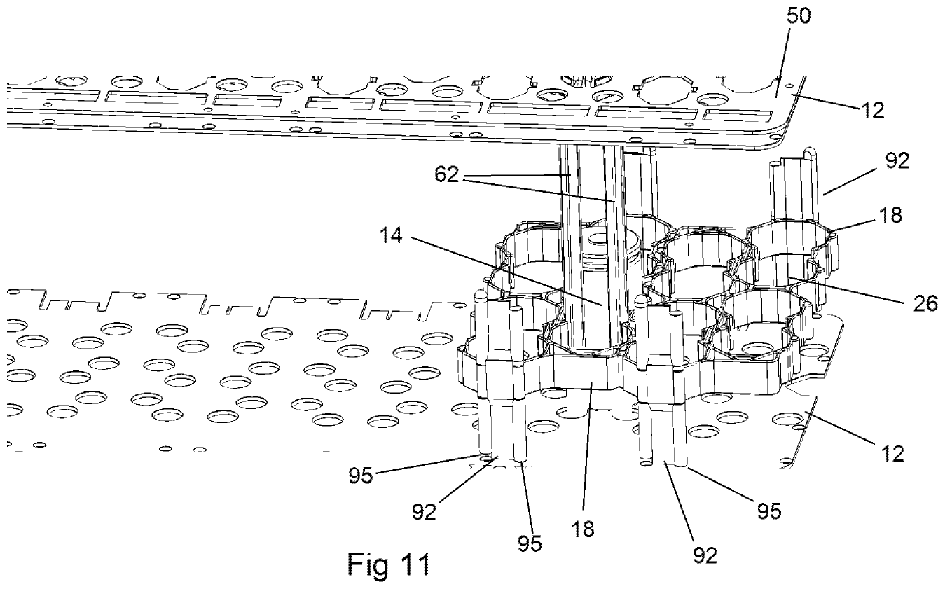

The tensioning members 32 in the embodiment of FIGS. 1 to 12 each comprise a pair of arms 62 extending from a resilient base member 64. The base member 64 is provided to engage with the outer side of a first endmost board 12. The arms 62 extend parallel to each other away from the base member 64 such that arms 62 are received through holes 20 provided in the boards 12. The arms 62 also pass through the cell guides 18. The arms 62 pass through the openings 26 in the frames 24 such that the arms 62 are located between a pair of cells 14 (as can be seen in FIG. 11). The frames 24 are also provided with further apertures 30 for receiving the arms 62 of a tensioning member 32. In the embodiment shown, a tensioning member 32 is provided to extending between each adjacent pair of cells 14 such that each column of cells 14 includes an adjacent tensioning member 32 to clamp the terminals of the cells 14 of the column to the contacts on the boards 12.

The tensioning members 32 provide a force that is sufficient to provide a reliable high current capability within the columns by overcome dust particles that may have been between the cell terminal and conductive surfaces of the boards 12 prior to assembly. The boards 12 have copper conductors that are nickel, tin or gold plated for electrical connection to the cells. The force is sufficient to slightly deform the copper surface of the boards ensuring a broad electrical contact to the cells 14 that overcomes any small dust particle that may be between the two during the assembly process.

Distal ends 66 of the arms 62 extend outwardly through an opposite second endmost board 12 and are secured to end members 38. The end members 38 are provided to be located on the outer surface of the second endmost board 12 such that distal ends 66 of the arms 62 of each of the tensioning members 32 engage with one of the end members 38.

Each of the end members 38 includes a body 39 to be placed adjacent an outer surface of the second endmost board 12 such that a first side surface 40 thereof is adjacent the outer surface of the board 12 and an opposite second side surface 41 of the body 12 is remote from the board 12. The body 39 of the end member 38 has a pair of notches 42 on opposed sides thereof. The distal ends 66 of the arms 62 are to be received on either side of the body 12 such that the distal ends 66 of the arms 62 pass through the notches 42.

The distal ends 66 of the arms 62 each include first teeth 68 on adjacent inner surfaces thereof. The notches 42 each include a flexible tab 44 therein such that the inner surfaces of the distal ends 66 of the arms 62 engage against outer surfaces of the tabs 44. The tabs 44 are flexible such that the tabs 44 may be flexed away from the distal ends 66 of the arms 62 in use and will resiliently move back towards the arms 62.

The outer surfaces of the tabs 44 also include a plurality of second teeth 46. The second teeth 46 on the tabs 44 and the first teeth 68 on the arms are shaped to allow movement of the distal ends 66 of the arms 62 through the notches 42 in direction away from the outer surface of the second endmost board 12 and restrict movement of the distal ends 66 of the arms 62 back towards the outer surface of the second endmost board 12.

The battery pack 10 is provided also with a locking plate 50. The locking plate 50 is to be received adjacent the outer surface of the second endmost board 12 and includes a plurality of openings 52 aligned to receive the end members 38. The openings 52 correspond generally in shape to the shape of the end members 38 and the end members 38 are provided with flexible clips 48 around the periphery thereof such that the flexible clips 48 engage with edges of the openings 52 such that when the end members 38 are received in the openings 52 and engaged by the arms 62, the locking plate 50 is engaged by lugs on distal ends of the clips 48 to restrict movement of the locking plate 50 away from the second endmost board 12.

Edges of the openings 52 extend across the outer ends of the notches 42 and include recesses 54 to align with the notches 42 in use and receive outer sides of the distal ends 66 of the arms 62. When the distal ends 66 of the arms 62 are received through the notches 42, the edges of the openings 52 in the locking plate 50 push the arms 62 towards the tabs 44 and thereby engage the first teeth 68 on the arms 62 with the second teeth 46 in the notches 42. The arms 62 may therefore be pushed through the notches 42 in the end members 38 but will be restricted from moving back through the end members 38.

The base member 64 of the tensioning member 34 includes a resilient mechanism such that, as the tensioning member 32 engages the outer surface of the first endmost board 12, the base member 64 may be pushed against the board 12 engaging the resilient mechanism. Pushing against the resilient mechanism allows the distal ends 66 of the arms 62 to pushed through the notches 42 in the end member 38. On release of the base member 64, the arms 62 are engaged with the end member 38 as described previously and placed under tension to hold the boards 12 together. A hinge point (not shown) of the tab 44 is set back from the mating teeth 46 and 68 such that a force engaging the teeth causes the hinged tabs 44 to proportionately press outwards against the arms 62 in a self-tightening action. The self tightening action operates in a manner similar that of cable ties.

The base member 64 comprises an elongate member 65 having first and second ends 70 and 71. The resilient mechanism is formed by the first and second ends 70 and 71 flexing about a central location between the first and second ends 70 and 71. A first side surface 72 of the base member 64 (being the side which engages the outer surface of the first endmost board 12) includes tapered outer ends such that portions of the first side surface 72 adjacent the first and second ends 70 and 71 engage the board 12 before the centre of the first side surface 72. Pressing the centre of the base member 64 toward the board 12 therefore flexes the centre of the base member 64 toward the first endmost board 12, thereby allowing movement of the arms 62 toward the second endmost board 12.

The base member 64 is flexible and resilient such that it will flex back after engagement with the board 12 to move the centre portion away from the board 12 and thereby apply tension to the arms 62. The base member 64 in the embodiment shown includes a central opening 74 in a second side surface thereof to receive a spring plate 76 extending from adjacent the first end 70 to adjacent the second end 71. The spring plate 76 is received under a cross member 78 extending centrally across the opening 74 between the first and second ends 70 and 71 on the second side surface of the base member 64. The base member 64 may therefore be flexed by pushing inwardly on the cross member 78, thereby flexing the spring plate 76.

The battery pack 10 is assembled by placing cells guides 18 containing cells 14 to sequentially build up the required number of layers of cells 14 between the first and second endmost boards 12 with the locking plate 50 in place on the second endmost board 12. The tensioning members 32 are passed through the holes 20 in the boards 12 to engage with the end members 38 provided in the openings 52 in the locking plate 50. By pressing the base members 64 of the tensioning members 32 inwardly toward the first endmost board 12, tension is applied to the boards 12 to retain the boards 12 in contact with the ends of the cells 14.

As the tensioning members 32 are distributed across the extents of the boards 12, a clamping force is applied evenly across the boards 12 in order to pull the contacts of the boards 12 into engagement with all of the terminals of the cells 14. The boards 12 may flex slightly under the distributed forces of the tensioning members 32 in order to engage with each of the columns of cells 14 with sufficient force. Such flexing of the boards 12 caused by the distributed tensioning members 32 allows for slight discrepancies in dimensions of the elements of the battery pack 10, such as the variations in heights of the cells 14.

When it is required to disassemble the battery pack 10, the locking plate 50 may be removed from adjacent the endmost board 12 by flexing the flexible clips 48 inwardly to disengage the locking plate 50 from the end members 38. The locking plate 50 may then be removed and the distal ends 66 of the arms 62 are then free to move away from the tabs 44 and thereby disengage from the end members 38 and release the tension securing the boards 12 together. Tab stops 130 allow re-use of the end member 38 by preventing the tabs becoming damaged by deflecting further than their design limits.

The tensioning members 32 and cell guides 18 are all expected to be made of a non-conductive material, such as a plastic material. This reduces the likelihood of shorts should the battery pack 10 be faulty or damaged. In the case of mobile applications, such as in a vehicle, this is particularly useful as a battery pack 10 may be broken apart in an accident. Further, in the event of excess heat caused by a faulty cell 14, the tensioning member would stretch and weaken, there disconnecting the cells 14.

The tensioning members 32 and/or end members 38 may also include a weakened section provided to allow breakage when subject to a sufficient impact force. In the case of an accident, the tensioning members 32 may thereby release and electrically disconnect at least some of the cells 14.

The layered approach with cell guides 18 provides easy assembly. Simple pack tensioning is provided by pressing and releasing the cross members 78. In a preferred embodiment, the rectangular spring plate 76 provides a 20 kg tension at a deflection of 3 mm and the 20 kg is sufficient to provide a reliable high current path through the columns having sandwiched printed circuit boards 12 that connect cells 14 to the monitoring and balancing system without the need for individual wires. The monitoring and balancing system may be designed partly or wholly onto the sandwiched printed circuit boards 12 reducing or removing the need for connectors 34.

The spring plate 76 arrangement is both low profile and simple but it is envisioned other tensioning mechanisms could be used such as cam, screw or bayonet. The elongate arms 62 are made of material 20% glass filled ABS to match the Thermal Coefficient of Expansion (TCE) of the cells. By matching the TCE with a material that provides stretch with a spring force but does not stretch over time, the spring material and ratchet mechanism can be replaced with tensioning members 32 that are screwed to provide the tension rather than being sprung with spring plate.

The battery pack 10 is also provided with one or more fan units 120 secured in the embodiment shown to one of the endmost boards 12. The fan units 120 are provided to draw air through the battery pack 10 via the holes 20 in order to provide cooling.

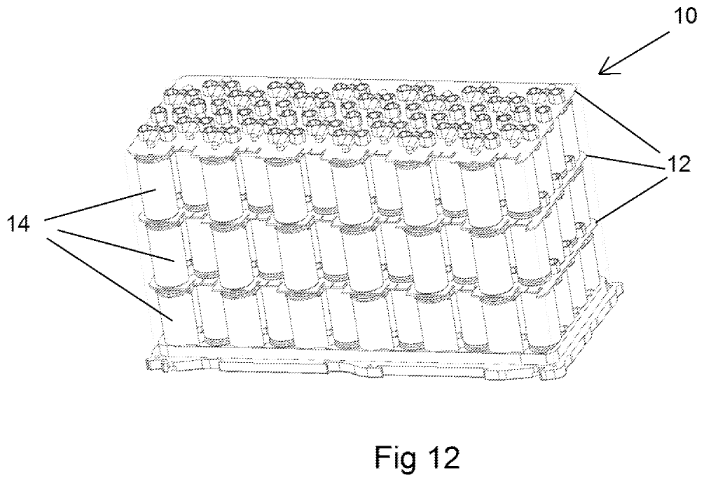

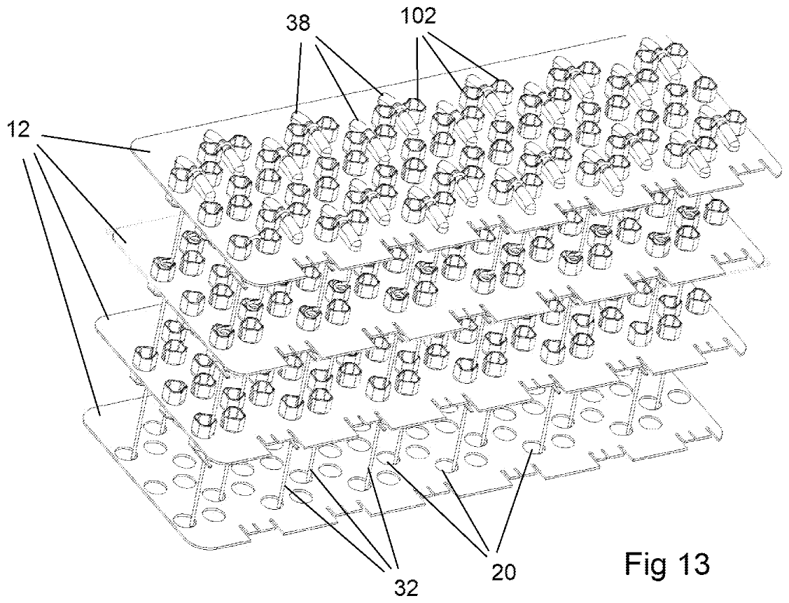

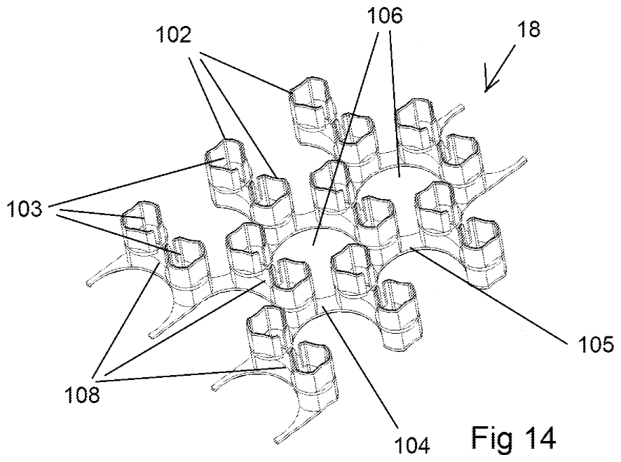

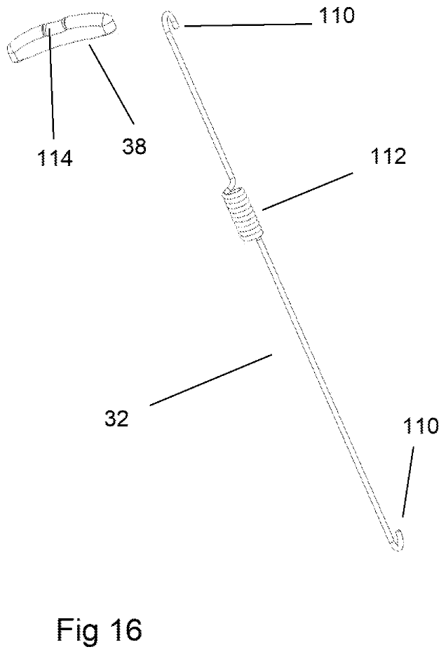

FIGS. 12 to 17 show a second embodiment of a battery pack in accordance with the present invention. The embodiment of FIGS. 12 to 17 is similar to the first embodiment and like reference numerals are used to denote like parts.

In the embodiment of FIGS. 12 to 17, the cell guides 18 are provided to engage with the boards 12 such that the cell guides 18 support the ends of the cells 18.

Each of the cell guides 18 comprises a plurality of tubular members 102 connected together by a frame 104. The cell guides 18 are formed from a flexible resilient material, such as a suitable plastic. Each of the tubular members 102 is sized such that the tubular member 102 may be inserted through one of the holes 20. When inserted through the holes 20, the cell guide 18 is supported such that a first end of each of the tubular members 102 extends outwardly for a first side surface of the board 12 and a second end of each of the tubular members 102 extends outwardly from a second opposed surface of the board 12.

The tubular members 102 are connected together by the frame 104 such that sets of tubular members 102 define the periphery of circular openings 126. The sets of tubular members 102 within a cell guide 18 may define a complete circular opening 126, or define a portion of the periphery of a circular opening 126 such that a further portion of the periphery of the circular opening 26 is defined by tubular members 102 of an adjacent cell guide 18. The circular openings 126 are dimensioned to receive ends of the cells 14 such that ends of the cells 14 are supported within the circular openings 126. The contacts are provided on the boards 12 centrally within the circular openings 26 such that ends of the cells 14 engage with contacts when the cells 14 are received in the openings 26.

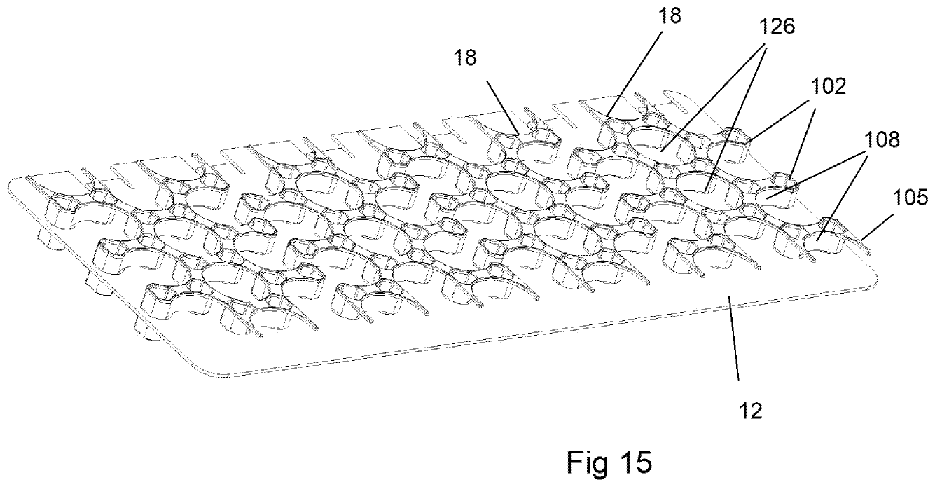

The frame 104 of each of the cell guides 18 comprises a planar member 105 connecting between first ends of the tubular members 102. The frame 104 includes a plurality of circular apertures 106 corresponding to the openings 126, as best seen in FIG. 15. The circular apertures 106 may include part circular apertures wherein the remaining portion of the aperture 106 is defined by the frame 104 of an adjacent cell guide 18.

The tubular members 102 of the cell guides 18 includes also a plurality of interconnecting portions 108 (as best seen in FIG. 15). The interconnecting portions 108 extend between adjacent pairs of tubular members 102 adjacent the first ends of the tubular members 102. The interconnecting portions 108 extend from the frame 104 to a location adjacent a midpoint of the tubular members 102 between the first and second ends thereof. When second ends of the tubular members 102 are inserted through the holes 20 in the boards 12, the interconnecting portions 108 engage with the surface of the board 12 when the tubular members are received partway through the boards 12. The interconnecting portions 108 thereby prevent further movement of the tubular members 102 through the boards 12 such that the tubular members 102 are supported with the ends thereof extending either side of the board 12.

The tensioning members 32 comprise elongate members of a suitable material, such as a metallic wire, to be received through central bores 103 in the tubular members 102. The tensioning members 32 extend from the first endmost board 12 through the aligned bores 103 in the tubular members 102 to the second endmost board 12.

The tensioning members 32 include hooks 110 on opposed ends thereof. The hooks 110 are provided to extend over the edges of the endmost tubular members 102 and engage with the endmost boards 12. The tensioning members 32 include spring portions 112 located between first and second ends such that the tensioning members 32 must be stretched to engage the hooks 110 with the endmost boards 12.

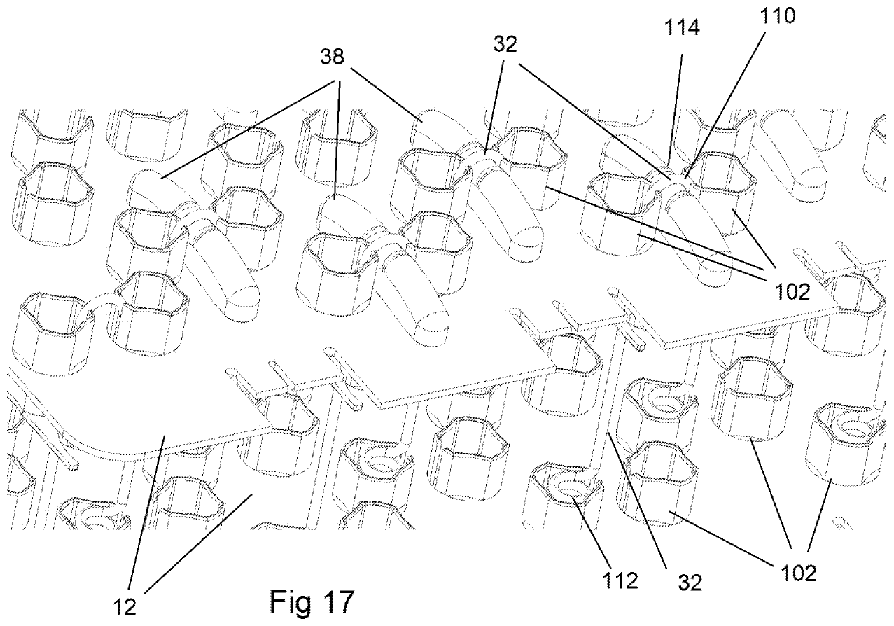

The battery housing 10 is provided with end members 38 locatable on outer surfaces of the endmost boards 12 between the tubular members 22, as can be seen in FIG. 17. The end members 38 comprise elongate members arranged against the outer surface of the endmost boards 12 such that a longitudinal axis of the end member 38 is parallel to the plane of the board 12. The end members 38 are located adjacent the tubular members 102 through which the tensioning members 32 extend. The hooks 110 are engaged over a central portion of the end members 38. The end members 38 include a notch 114 located centrally on a side surface thereof into which the hooks 110 are engaged.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A battery pack comprising:
a plurality of boards having contacts thereon for contacting terminals of a plurality of layers of cells, each layer of cells being received between an adjacent pair of boards;
a plurality of cell guides provided to each receive a plurality of the cells such that when the cell guides are received between the adjacent pair of boards, terminals of the cells are located adjacent contacts on the boards; and
a plurality of tensioning members;
wherein the tensioning members pass through aligned holes in each of the boards to engage with first and second endmost boards in order to pull together the boards, the tensioning members being distributed across the extents of each of the boards in order to distribute a clamping force across the boards in order to engage the terminal of the cells with the contacts on the boards.

28. A battery pack in accordance with claim 27, wherein each of the boards includes contacts on first and second side surfaces being aligned such that the cells form columns of connected cells.

29. A battery pack in accordance with claim 28, wherein at least one tensioning member is provided adjacent each of the columns of cells to clamp the terminals of the cells of the columns into contact with the contacts on the boards.

30. A battery pack in accordance with claim 29, wherein a tensioning member is provided between each adjacent pair of columns of cells.

31. A battery pack in accordance with claim 27, wherein each of the tensioning member comprises an elongate member having opposed ends thereof engaged with the first and second endmost boards.

32. A battery pack in accordance with claim 27, wherein the contacts on the first and second side surfaces of the boards are each connected to a conductor extending along the side surfaces of the boards to one of a plurality of edge connectors provided along an edge of the board to allow for monitoring by a control unit of the characteristics of the cell in use.

33. A battery pack in accordance with claim 32, wherein a connector is provided for engaging with the edge connectors of each of the boards in order to provide connection to the control unit.

34. A battery pack in accordance with claim 33, where the connectors are flexible such that the connectors will allow for some relative movement of the boards when tensioning the battery pack.

35. A battery pack in accordance with claim 27, wherein the tensioning members each comprise a pair of arms extending outwardly from a base member, the arms being received through holes in the boards such that when the base member engages with a first endmost board, distal ends of the arms engage with an end member located adjacent a second endmost board.

36. A battery pack in accordance with claim 35, wherein the base member is resiliently flexible such that the base member may be pushed toward the first endmost board such that the distal ends of the arms engage with the end member, thereby applying tension when the base member is released.

37. A battery pack in accordance with claim 36, wherein the end members each have flexible tabs aligned with the arms such that first teeth on inner surfaces of distal ends of the arms engage with second teeth on outer surfaces of tabs to allow movement of the arms relative to the end member in a direction away from an outer surface of the second endmost board but restrict movement of the arms back towards the outer surface of the second endmost board.

38. A battery pack in accordance with claim 37, wherein the first and second teeth comprise triangular teeth provide to engage with each other and thereby restrict motion of the distal ends of the arms through the end members in a direction toward the outer surface of the second endmost board.

39. A battery pack in accordance with claim 37, wherein a locking plate is provided having openings to receive the end members such that edges of the openings align the distal ends of the arms towards the tabs, thereby engaging the first teeth on the arms with the second teeth on the tabs.

40. A battery pack in accordance with claim 39, wherein the openings in the locking plate correspond in shape to the shape of the end members and the end members are provided with flexible clips around the periphery thereof such that the flexible clips engage with edges of the openings to hold the locking plate relative to the second endmost board.

41. A battery pack in accordance with claim 36, wherein the base member comprises an elongate member having first and second ends and includes a resilient mechanism formed by the first and second ends flexing about a central location between the first and second ends.

42. A battery pack in accordance with claim 41, wherein a first side surface of the base member includes tapered outer ends such that portions of the first side surface adjacent the first and second ends engage the board before a centre of the first side surface, such that pressing the centre of the base member toward the board resiliently flexes the base member.

43. A battery pack in accordance with claim 42, wherein the base member includes a central opening on a first side surface thereof to receive a spring plate extending from adjacent the first end to adjacent the second end.

44. A battery pack in accordance with claim 43, wherein the plate is received under a cross member extending centrally across the opening between the first and second ends on a second side surface of the base member such that the base member may be flexed by pushing inwardly on the cross member, thereby flexing the plate.

45. A battery pack in accordance with claim 27, wherein the tensioning members comprise elongate wires having hooks on opposed ends thereof to engage with end members locatable on outer surfaces of the endmost boards.

46. A battery housing in accordance with claim 45, wherein the hooks are engaged into notches on a central portion of the end members.

47. A battery pack in accordance with claim 27, wherein the cell guides comprise a frame formed from a plurality of the tubular portions, each of the tubular portions being provided to receive one or more cells.

48. A battery pack in accordance with claim 47, wherein the cell guides are formed from a flexible resilient material.

49. A battery housing in accordance with claim 48, wherein the cell guides are provided with locating members to engage with the frame and engage also with the boards in order to locate the cell guides relative to the boards.

50. A battery housing in accordance with claim 49, wherein the locating members each comprise one or more rods having first ends receivable in support holes provided around the periphery of the frame and second ends receivable in locating holes provided on the boards.

51. A battery housing in accordance with claim 27, wherein the tensioning members or end members include a weakened section to allow breakage when subject to a sufficient impact force in order to electrically disconnect some of the cells.

52. A battery housing in accordance with claim 27, wherein there is provided three layers of cells and four boards.
